(19) United States
(12) Patent Application Publication
(10) Pub. No.: US 2016/0207078 A1
(43) Pub. Date: Jul. 21, 2016

(54) OPTICAL ARRANGEMENT, IN PARTICULAR PLASMA LIGHT SOURCE OR EUV LITHOGRAPHY SYSTEM

(71) Applicant: Carl Zeiss SMT GmbH, Oberkochen (DE)

(72) Inventors: Moritz BECKER, Stuttgart (DE); Ulrich MUELLER, Aalen (DE); Oliver ARP, Aalen (DE)

(21) Appl. No.: 15/082,735

(22) Filed: Mar. 28, 2016

Related U.S. Application Data
(63) Continuation of application No. PCT/EP2014/067540, filed on Aug. 18, 2014.

(30) Foreign Application Priority Data
Sep. 27, 2013 (DE) 10 2013 219 585.0

(51) Int. Cl. B08B 7/00; B08B 5/04

(52) U.S. Cl. CPC B08B 7/0092; B08B 5/04

(57) ABSTRACT

An optical arrangement, in particular a plasma light source (1′) or an EUV lithography apparatus, with a housing (2), which encloses an interior housing space (3), a vacuum generating unit for generating a vacuum in the housing (2), at least one surface (13), which is disposed in the interior housing space (3), a cleaning device (15) which removes contaminating substances (14) deposited on the surface (13), and also a monitoring device (25) which monitors the surface (13), the monitoring device (25) having monitoring optics (26) that can be directed onto the surface (13). The cleaning device (15) is configured to remove the deposited contaminating substances (14) by the discharge of CO₂ in the form of CO₂ pellets (17).

### CROSS REFERENCE TO RELATED APPLICATIONS

This is a Continuation of International Application PCT/EP2014/067540, which has an international filing date of Aug. 18, 2014, and the disclosure of which is incorporated in its entirety into the present Continuation by reference. The following disclosure is also based on and claims the benefit of and priority under 35 U.S.C. §119(a) to German Patent Application No. DE 10 2013 219 585.0, filed Sep. 27, 2013, which is also incorporated in its entirety into the present Continuation by reference.

### FIELD OF THE INVENTION

The invention relates to an optical arrangement, in particular a plasma light source or an EUV lithography apparatus.

### BACKGROUND

US 2008/0042591 A1 discloses a plasma light source for generating light with a plasma. The plasma light source has a chamber, in which an ionizable medium that is used for generating the plasma is contained. For this purpose, an electric current is induced with a transformer, which has a magnetic core and a primary coil. The primary coil typically has a copper housing, which at least partially encloses the magnetic core and provides a conductive connection. Xenon, lithium or tin may be used for example as the ionizable medium, it being possible for these substances to take a gaseous, liquid or solid form, for example finely distributed solid particles (for example tin particles). Such solids may for example be evaporated with a steam generator and subsequently introduced into the chamber. The chamber is generally formed from metal materials, in order to confine the plasma inside the chamber. Energy is fed in, typically in a pulsed form, by an energy supply device.

The plasma generated by the plasma light source (or the plasma discharges generated with the plasma source) may be used for generating light or electromagnetic radiation, which in turn can be used for a large number of applications. Such a plasma light source may serve in particular for generating EUV radiation, which can be used in a metrology system for EUV lithography, for example in the metrology system described in WO 2011/161024 A1.

It has been found to be problematic when generating radiation with known plasma light sources, which are based on radiation generation by reducing the cross section of the plasma (“pinching”), that the radiation generated is unstable, i.e. one or more radiation pulses drop out from time to time. These instabilities are substantially attributable to freely movable particles in the chamber or to material deposited on the inner walls of the chamber. On account of the aggressive plasma environment in the vicinity of the plasma discharge, material is removed from the chamber walls that are facing the plasma and deposited at other points further away from the plasma discharge, in particular on the chamber wall. The deposited material has the tendency to peel off in the form of flakes, which disturb the plasma and cause the described drop-outs or instabilities of the plasma light source.

Cleaning such a plasma light source is typically performed by carrying out a cleaning procedure in which a gas stream of an inert gas, for example nitrogen, is used to swirl up detached flakes and deposited particles and extract them with a suction extracting device, for example in the manner of a vacuum cleaner. This cleaning procedure is time-consuming and not very effective.

WO 2009/152885 A1 discloses an optical arrangement for mounting in an EUV lithographic projection exposure apparatus, arranged inside of which is an optical element with an optical surface that can be cleaned, i.e. freed of deposited particles, with a particle cleaning device. The cleaning device may be formed in various ways. For example, cleaning the optical surface may be performed by using a procedure referred to as “snow cleaning”, for example using carbon dioxide (CO₂), in which liquid or gaseous CO₂ is made to expand through a nozzle in order to bring about high outlet velocities and bring about an expansion of the carbon dioxide with the formation of CO₂ snow, i.e. CO₂ in the form of microscopic solid particles. The “snow cleaning” procedure is not abrasive and can therefore be used for cleaning optical surfaces that have an optical coating, as is generally the case with reflective optical elements for EUV lithography.

### SUMMARY

An object of the invention is to provide an optical arrangement that allows effective cleaning of contaminating substances deposited on surfaces of the arrangement.

This and other objects are achieved with an optical arrangement, in particular by a plasma light source or an EUV lithography apparatus, with a housing, which encloses an interior housing space, a vacuum generating unit configured to generate a vacuum in the housing, at least one surface, which is disposed in the interior housing space, and a cleaning device configured to remove contaminating substances deposited on the surface, the cleaning device being configured to remove the deposited contaminating substances by the discharge of CO₂ in the form of CO₂ pellets. For the purposes of this application, a surface disposed in the interior housing space is understood as also meaning an inner housing wall.

The CO₂ pellets that are discharged and are incident on the surface(s) to be cleaned even allow contaminating substances that are firmly attached to the surface or otherwise can only be removed with great difficulty to be removed effectively from the surface or the surfaces. The CO₂ pellets or CO₂ beads are dry pieces of CO₂ ice, i.e. particles of solid matter with comparatively great diameters or average diameters of the order of magnitude of millimetres. After being incident on the surface, the CO₂ pellets typically (in particular under low pressures in the interior housing space) go over into the gaseous state, so that residue-free cleaning is made possible. The cleaning action when using the CO₂ pellets is achieved as a result of the thermal shock on impact with the surface and the spontaneous increase in volume during the sublimation. In this way, even comparatively thick layers, in particular macroscopically thick layers with layer thicknesses in the range of several millimetres, can be removed with comparatively little expenditure of time. The cleaning action with CO₂ pellets may possibly be abrasive, though gentle cleaning is possible, especially in the case of soft base materials (for example aluminium), since the impact energy of the CO₂ pellets is low in comparison with sandblasting, and the cleaning action is substantially based on the effects described above and not on the mechanical impact.

For cleaning the surface with CO₂ pellets, the CO₂ pellets are generated in the desired size (generally between 0.01 mm and 10 mm). The CO₂ pellets may be fed to a gas stream (in particular an inert gas stream) and entrained and accelerated by it. Alternatively, a purely mechanical acceleration may be performed. In any event, the CO₂ pellets are directed or “fired” onto the surface to be cleaned. For generating the CO₂ pellets of the desired size, larger pieces of CO₂ ice may be broken down into correspondingly smaller pieces of CO₂ ice. For this purpose, the cleaning device may for example comprise a correspondingly formed CO₂ pellet processing unit. The processing unit may be designed to vary the CO₂ pellet size according to how severe the soiling by the contaminating substances is or how strongly they are attached to the surface. Furthermore, with the aid of the cleaning device, for example by variation of the pressure with which the CO₂ pellets are discharged or the flow velocity of the gas in which they are entrained, the impact velocity or outlet velocity can be varied. The cleaning device typically comprises furthermore a CO₂ source (for example a CO₂ storage container). The cleaning device may be detachably connected to the housing, for example by way of an adapter or a service console. When no cleaning is required, the cleaning device can be detached from the housing and the opening on the housing can be closed with a covering or the like.

In one embodiment, the cleaning device has for feeding the CO₂ pellets to the surface a feeding device, which comprises a feed line with an outlet opening for discharging the CO₂ pellets, the feed line having at least one flexible section of line for directing the outlet opening onto various points of the surface. The flexible section of the feed line allows the outlet opening, which may be formed as a nozzle opening of a gas nozzle, to be directed from various spatial directions (flexibly) onto the surface to be cleaned. The flow cross section of the outlet opening or the gas nozzle may also be variable, in order to vary the angular distribution of the emerging CO₂ pellets. The feeding device or the flexible section of line of the feeding device makes it possible to reach even difficultly accessible regions or dead spaces in the interior housing space.

Consequently, the angle of incidence of the CO₂ pellets on the surface and/or the distance of the outlet opening from the surface can also be varied, depending on how severe the soiling by the deposited contaminating substances is at the various points of the surface.

The flexible section of line may be formed between two rigid sections of the feed line. The flexible section of line may however also form an end section of the feed line in the region of the outlet opening. The feed line may also comprise a further or a number of further flexible sections of line, it being possible for a rigid section of line to be respectively provided between adjacent flexible sections of line. The use of at least one flexible section allows the feed line altogether to be directed very flexibly onto the corresponding points of the surface to be cleaned in the manner of an endoscope. Pulling and/or pushing elements, which influence or change the curvature of the flexible section of line, may for example serve for directing the outlet opening onto the various points of the surface. Bowden cables, which can in principle run inside or outside the feed line, may be used in particular as pulling and/or pushing elements.

In a preferred development, the feed line is inserted in the interior housing space in a gastight manner through an opening in the housing, so that the CO₂ pellet cleaning can be carried out in situ. This dispenses with a laborious procedure of disassembling the optical arrangement for cleaning the surface. To achieve a gastight close-off, the opening in the housing may correspond with respect to its size (for example its diameter) to the overall cross section of the feed line. Using the feed line inserted in the interior housing space through the opening, the CO₂ pellets are directed into the interior of the housing from outside the housing. The opening may in principle also be larger than the overall cross section of the feed line, corresponding sealing devices having to be provided in this case to achieve the gastight close-off.

Also preferred is a development in which, for directing the outlet opening, the feed line, in particular a rigid section of the feed line, is displaceable and/or rotatable in relation to the opening. For example, an axial seal, which allows an axial relative movement between the feed line or the rigid section of line and the opening, may be provided and/or a radial seal, which allows a rotational relative movement between the feed line or the rigid section of line and the opening, may be provided.

In a preferred embodiment, the optical arrangement comprises a monitoring device for monitoring the surface, the monitoring device having monitoring optics that can be directed onto the surface. The monitoring optics may be for example an imaging optical unit with microlenses, which projects an image of the surface or part of the surface onto an image sensor, for example onto a CCD chip. The monitoring device is designed to monitor the cleaning of the surface with the CO₂ pellets, i.e. to record the cleaning operation and/or reproduce it on a screen. On the basis of the monitoring of the surface, it is possible for example to determine the initial degree of contamination of the surface. It is similarly possible to monitor the cleaning operation itself and in particular to keep a check on the cleaning progress. Finally, a time for discontinuing the cleaning procedure may also be determined on the basis of the signals obtained by the monitoring optics.

In a preferred development, the monitoring optics are mounted on an image transmission line, which has at least one flexible section of line for directing the monitoring optics onto various points of the surface. The image transmission line typically also serves for providing illumination radiation for illuminating the surface to be monitored. The image transmission line may have at least one further or a number of further flexible sections of line, it being possible for rigid sections of line to be provided between adjacent flexible sections of line. As a result, the transmission line as a whole can be used very flexibly in the manner of an endoscope and the monitoring optics can be directed onto the appropriate points of the surface to be cleaned for selective monitoring. The monitoring device or the flexible section of line of the monitoring device makes it possible to examine difficultly accessible volumes or dead spaces of the interior housing space. The transmission line is typically one or more light guides, in particular in the form of glass fibres. The transmission of the image may take place in an analog manner, for example with the aid of microlenses, or in a digital manner. In the latter case, the monitoring optics form an image sensor, for example a CCD or CMOS chip, which is provided at the end portion of the transmission line that is facing the surface. It is also possible to use as the image transmission line a multiplicity of glass fibres, which respectively serve the purpose of transmitting an individual image point of the recorded image of the surface for example to a display device (for example a monitor) for presenting the recorded image, which can be watched by an operator of the cleaning device.

Preferably, the feed line and the image transmission line are arranged next to one another, in particular are connected to one another at least in sections. In this way the feed line and the image transmission line can be moved together (as one) and directed together. The in-situ cleaning with CO₂ pellets and the in-situ monitoring using the monitoring optics can in this way be carried out particularly easily. In particular, both can be suitably directed or moved by an operator using a suitable handling device, which is disposed outside the housing, in order to carry out the cleaning.

In a preferred development, the direction of discharge of the CO₂ pellets and the direction of monitoring of the monitoring optics run parallel or coaxially in relation to one another. In this way, the action of the pellets when they are incident on the surface can be observed particularly easily, making it easier to operate the cleaning device or keep it under open-loop/closed-loop control.

In a preferred embodiment, the cleaning device comprises a suction extracting device for extracting removed contaminating substances and/or CO₂ from the interior housing space. The suction extracting device not only allows removed contaminating substances to be extracted completely from the housing, whereby they can no longer have a contaminating effect inside the housing, but also allows the CO₂ pellets introduced into the interior housing space or the CO₂ gas produced by the transformation into the gaseous phase to be completely extracted from the interior housing space. The extracted CO₂ gas may be reused by the cleaning device, in particular by the processing unit of the cleaning device, for generating further CO₂ pellets. The suction extracting device typically comprises a filter unit for separating the contaminating substances from the CO₂ gas.

In a preferred development, the suction extracting device has at least one suction extracting line entering the interior housing space in a gastight manner. The gastight feed line for the CO₂ pellets into the interior housing space and also the suction extracting line entering the interior housing space in a gastight manner allow an altogether gastight cleaning cycle to be formed. The at least one suction extracting line preferably enters the interior of the housing in a gastight manner by way of a connection part, the passage cross section of which increases towards the interior of the housing, i.e. by way of a typically funnel-shaped connection part. The suction extracting line may also have at least one flexible section of line, in order to be able to direct or position a suction extracting opening of the suction extracting line suitably in the interior housing space. This is advisable in particular in connection with the (mobile) space dividing device described further below.

In a preferred development, the suction extracting line enters the interior of the housing in the region of the surface to be cleaned. In this way, the extraction of the removed contaminating substances takes place in a region that is directly adjacent to the depositing location (of the surface), so that the path to be covered by the contaminating substances during the extraction is particularly short. Consequently, the removed contaminating substances cannot be initially swept away and deposited at other points of the housing (on other surfaces of the housing or on other surfaces in the housing), but are immediately removed from the interior of the housing. Such (direct) extraction advantageously allows any cross contamination to be reduced or even eliminated entirely.

In a further development, the or at least one suction extracting line enters the interior of the housing through an opening of a feed line for feeding in the CO₂ pellets, whereby a particularly compact arrangement can be realized.

Also preferred is an embodiment in which the surface is an inner surface of a housing of a plasma light source. Removing the contaminating substances from the inner housing surface of the plasma light source with the CO₂ pellets advantageously allows the effect to be achieved that there is no drop-out of individual radiation pulses during the operation of the light source. It is also possible to achieve the effect that so-called source debris, i.e. a discharge of gaseous, liquid or solid foreign material (for example droplets or particles) from the light source into the connected optical device, for example an illumination system, does not occur or that it is at least greatly reduced.

Also preferred is an embodiment in which the surface is formed on a (structural) component arranged in the interior housing space. The cleaning of the surface of the structural component can be advantageously carried out by the CO₂ pellets in such a way that a subsequent (re)adjustment of the structural component is not required. The structural component may be in particular a mounting for an optical element, for example for an EUV mirror, which may for example be arranged in an EUV lithography apparatus or in an EUV metrology system. In particular, structural components or housing parts of a plasma light source in which a plasma is not generated by magnetic confinement but by laser radiation, especially by CO₂ laser radiation, may also be cleaned in the way described above, in that these surfaces are exposed to the CO₂ pellets. In this way it is possible in particular for deposits of tin or tin compounds to be removed from the surfaces of the plasma light source.

In a further embodiment, the surface is an optical surface of an optical element that is reflective for EUV radiation, which may for example be arranged in an EUV lithography apparatus or in an EUV metrology system. Since then CO₂ pellets have an abrasive action, cleaning with the aid of CO₂ pellets may lead to partial removal of or damage to the optical surface or a reflective coating on which the optical surface is formed. However, cleaning with CO₂ pellets is suitable for the removal of contaminants that cannot be removed in another way, or only with considerable effort, and can be used with preference selectively in localized regions of the optical surface in which the thickness of the layer to be removed is great enough that the reflective coating lying thereunder is not exposed, or only slightly, to the abrasive action of the CO₂ pellets.

Also preferred is an embodiment in which a space dividing device surrounding the surface and the cleaning device, in particular in a gastight manner, is provided in the interior housing space. The surface to be cleaned is in this case preferably an inner surface of the housing or a surface that is formed on a component arranged in the interior housing space. The space dividing device may for example be laid against the housing or against the inner surface of the housing or against the component arranged in the interior housing space. The fact that the space dividing device surrounds or encloses the cleaning device and the surface to be cleaned, in particular in a gastight manner, makes it possible to prevent CO₂ pellets or contaminating substances produced during the cleaning from getting into the region of optical surfaces (in particular surfaces of an EUV radiation-reflecting optical element) that are disposed outside the partial volume delimited by the space dividing device. In this way, by using the space dividing device, cleaning with CO₂ pellets can even be carried out in the direct vicinity of optical surfaces without damaging the optical surfaces.

The space dividing device may be formed example in the manner of a hemispherical cap or bell. In particular, the space dividing device may be mounted in the interior housing space in a mobile or movable manner, for example a displaceable manner, and be able to be moved to various positions within the housing in order to allow surfaces disposed at various locations in the housing to be cleaned. The fact that the space dividing device surrounds the surface and the cleaning device means that the feeding device and the suction extracting device of the cleaning device are at least partially arranged in the partial volume that is delimited by the space dividing device. In this way, a closed cleaning cycle can be set up inside the delimited partial volume.

Finally, an embodiment in which the outlet opening of the feed line and an end on the inlet side of the suction extracting line are surrounded by the space dividing device is preferred. In this way, both the outlet opening and the end on the inlet side of the suction extracting line are arranged in the partial volume that is delimited by the space dividing device, or protrude into it. The monitoring device is typically also at least partially inserted in the partial volume that is delimited by the space dividing device, i.e. at least the monitoring optics, in order to monitor there the surface to be cleaned, for example in order to identify points where there is increased contamination and/or to monitor the cleaning progress.

Further features and advantages of the invention emerge from the following description of exemplary embodiments of the invention, on the basis of the figures in the drawing, which show details essential to the invention, and from the claims. The individual features can be realized respectively on their own or together in any combination in one variant of the invention.

### BRIEF DESCRIPTION OF THE DRAWINGS

Exemplary embodiments are represented in the schematic drawing and are explained in the subsequent description. In the figures:

FIG. 1 shows a schematic representation of an optical arrangement in the form of a plasma light source,

FIG. 2 shows a detail of the plasma light source from FIG. 1 with a cleaning device,

FIG. 3 shows a schematic representation of an optical arrangement that is formed as an EUV lithography apparatus,

FIG. 4 shows a detail of the EUV lithography apparatus from FIG. 3, and

FIG. 5 shows a schematic representation of a further possibility for mounting a cleaning device in the plasma light source from FIG. 1.

### DETAILED DESCRIPTION

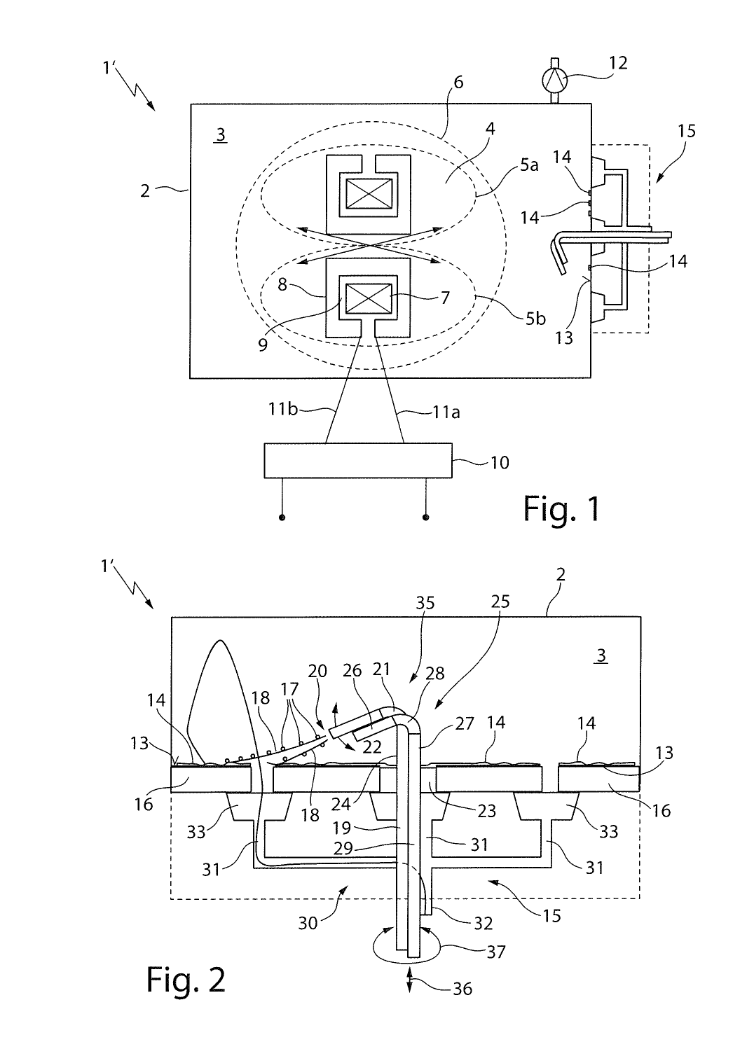

In FIG. 1, a schematic cross section through an optical arrangement in the form of a plasma light source 1′ is represented. The plasma light source 1′ or the optical arrangement comprises a housing 2, which is formed as a chamber and encloses an interior housing space 3. The housing 2 encloses also a plasma discharge region 4 with an ionizable medium. The ionizable medium is used for generating the plasma (represented by two plasma loops 5a and 5b) in the plasma discharge region 4. The plasma light source 1′ further comprises a transformer 6 for inducing an electric current in the two plasma loops 5a and 5b that are formed in the plasma discharge region 4. The transformer 6 has a magnetic core 7 and a primary coil 8, a gap 9 being formed between the coil 8 and the magnetic core 7. The two plasma loops 5a and 5b converge and draw together in a central region to form a plasma filament (“pinching”), i.e. the cross-sectional area of the plasma of the respective plasma loop 5a, 5b is reduced there, and consequently the energy density of the plasma is increased. As a result of the increased energy density, the radiation of the plasma light source 1′ (indicated in FIG. 1 by arrows) is generated substantially in the central region, so that an approximately punctiform light source, which can for example emit EUV radiation, i.e. radiation in a wavelength range between about 5 nm and about 30 nm, can be realized with the plasma light source 1′.

The plasma light source 1′ also comprises an energy supply device 10, with which electrical energy can be provided, typically in a pulsed form, for the primary coil 8 or for the magnetic core 7. During the operation of the plasma light source 1′, the energy supply device 10 generally provides a series of energy pulses for this purpose, and consequently feeds energy to the plasma. The energy supply device 10 provides the energy pulses or the series of energy pulses by way of electrical connections 11a and 11b, the energy pulses inducing an electric current in the magnetic core 7, whereby the energy is made available to the plasma loops 5a and 5b in the plasma discharge region 4.

An ionizable fluid, i.e. a gas or a liquid, may be used as the ionizable medium. The ionizable medium may be for example xenon, lithium or tin. Alternatively, the ionizable medium may consist of finely distributed solid particles (for example tin particles), which are directed into the housing 2 by a carrier gas, for example helium, by way of a gas feed line. A solid matter, such as for example tin or lithium, which is evaporated with an evaporation process or by so-called “sputtering”, may likewise be used as the ionizable medium.

The plasma light source 1′ may further comprise a steam generator (not represented), which evaporates such metals and introduces the evaporated metal into the housing 2. The plasma light source may further comprise a heating device for heating the evaporated metal in the housing 2 (likewise not represented). The housing 2 is typically at least partially formed by a metal material, for example copper, tungsten, a tungsten-copper alloy or some other material that confines the ionizable medium and the plasma in the interior of the housing 2. The plasma light source 1′ further comprises a vacuum generating unit 12 for generating a vacuum in the housing 2 (for example at pressures between about 10⁻⁹ mbar and 10 mbar) and a surface 13, which is disposed in the interior housing space 3, i.e. in the chamber, and which in FIG. 1 forms an inner surface of the housing 2 of the plasma light source 1′.

During the generation of the plasma by the plasma light source 1′, however, instabilities in the generation of the radiation may occur on account of contaminating substances located within the housing 2, in particular if the contaminating substances are suddenly detached in the form of comparatively large flakes from surfaces present in the plasma light source 1′, as a result of which the plasma is disturbed and drop-outs of individual pulses or of series of pulses may occur. The contaminating substances may be produced if parts of the housing wall, for example containing copper, that are facing the plasma, in particular in the plasma discharge region 4, are removed from the housing 2 or from the primary coil 8 or its envelope. These removed substances may then spread out in the interior housing space 3 and be deposited once again at various points of the housing 2 (for example on the surface 13) and detach spontaneously from the surface 13 in the form of flake-like conglomerates. For removing substances 14 deposited on the surface 13, the plasma light source 1′ has a cleaning device 15, which is described more specifically below on the basis of FIG. 2.

In the enlarged detail shown in FIG. 2 of the plasma light source 1′, the housing 2 enclosing the interior housing space 3 is represented in a simplified form without the components that are used in FIG. 1 for generating the plasma. In FIG. 2, the interior housing space 3 is delimited on its underside by way of example by the surface 13, which forms the inner side of the housing wall 16. The housing wall 16 is typically at least partially formed by a metal material, for example copper or tungsten.

The cleaning device 15 for removing the contaminating substances 14 deposited on the surface 13, which are typically likewise of metal material, is designed to remove the deposited contaminating substances 14 by discharging CO₂ in the form of CO₂ pellets 17. For generating the CO₂ pellets, the cleaning device 15 may for example comprise a CO₂ storage device and also a CO₂ pellet processing unit (not represented). The CO₂ pellet processing unit or the cleaning device 15 then allows the CO₂ provided by the CO₂ storage device to be transformed into pieces of CO₂ ice of the appropriate size, which form the CO₂ pellets 17, for example in that large pieces of CO₂ ice are crushed until they are of the desired size, which is typically of the order of magnitude of 0.01 mm to 10 mm.

Subsequently, the cleaning device 15 accelerates the CO₂ pellets 17 using an inert gas stream 18, which may be generated for example by a pressure gradient when the gas leaves a storage device, in which the inert gas is kept under high pressure. The CO₂ pellets 17 are fed to the inert gas stream 18 and entrained by the latter and accelerated with the gas nozzle provided at the outlet opening 20, so that the CO₂ pellets 17 in the gas stream 18 are incident on or impact the surface 13 to be cleaned at high velocity (typically of Mach 0.7 to Mach 3.0) and (abrasively) remove the contaminating substances 14.

For feeding the CO₂ pellets 17 to the surface 13, the cleaning device 15 has a feeding device 35, which comprises a feed line 19 with an outlet opening 20 of a gas nozzle for discharging the CO₂ pellets 17. The feed line 19 has at least one flexible section of line 21 for directing the outlet opening 20 or the outlet nozzle onto various points of the surface 13. For directing the outlet opening 20, the end on the outlet opening side of the feed line 19 can be pivoted in a way corresponding to the direction of the arrow 22 (in the plane of the drawing of FIG. 2). Furthermore, the end on the outlet opening side of the feed line 19 may also be pivoted in a plane extending perpendicularly in relation to the plane of the drawing of FIG. 2, in order to guide or direct the stream 18 of inert gas and CO₂ pellets 17 emerging from the outlet opening 20 onto various points of the surface 13, for which reason the feeding device 35 has suitable movement devices, which may for example be realized in the form of Bowden cables or the like.

The feed line 19 is inserted in the interior housing space 2 in a gastight manner through an opening 23 in the housing 2. The directing of the outlet opening 20 or the outlet nozzle onto different points of the surface 13 is facilitated by the feed line 19, to be more precise a rigid section 24 of the feed line 19, being displaceable in the axial direction and/or rotatable in relation to the opening 23 (cf. corresponding arrows 36, 37). To allow the relative displacement and/or rotation, corresponding axial and/or radial seals may be provided between the opening 23 and the feed line 19.

The CO₂ pellets 17 discharged from the cleaning device 15 advantageously allow contaminating substances 14 that are relatively thick and strongly attached to the surface 13, and therefore otherwise difficult or impossible to remove, typically layers of contaminating substances 14, to be removed effectively from the surface 13. Furthermore, the flexible design of the feed line 19, in particular the possibility of directing the end on the outlet opening side of the feed line 19 in various spatial directions, in the ideal case allows all of the inner sides of the housing 2 or all of the surfaces 13 disposed in the interior of the housing 3 to be reached by the discharged CO₂ pellets 17 and consequently be cleaned. The surfaces 13 may be in particular surfaces of components that are arranged in the interior housing space 3, for example the primary coil 8 or its envelope.

The plasma light source 1′ further comprises a monitoring device 25 for monitoring the surface 13, with monitoring optics 26 that can be directed onto the surface 13. In the example shown, the monitoring device 25 comprises an image transmission line 27, on which the monitoring optics 26 are mounted and which has a flexible section of line 28 for directing the monitoring optics 26 onto various points of the surface 13. By analogy with the end on the outlet opening side of the feed line 19, the flexible section of line 28 has the effect that the monitoring optics 26 can also be directed in various spatial directions in a way corresponding to the direction of the arrow 22 and consequently to various points of the surface 13. The feed line 19 and the image transmission line 27 are arranged next to one another and are connected to one another or fastened to one another at least in certain sections.

In the example shown, the rigid section of line 24 on the outlet opening side of the feed line 19, with the gas nozzle or outlet opening 20, and a rigid section of line 29 on the monitoring optics side of the image transmission line 27 are connected to one another. In this way, the direction of discharge of the CO₂ pellets 17 from the feed line 19 and the direction of monitoring of the monitoring optics 26 can be aligned parallel to one another. The fastening allows the feed line 19 and the image transmission line 27 to be moved together by using a single movement device. The feed line 19 and the image transmission line 27 do not necessarily have to be fastened to one another. In particular, it may be advantageous if the monitoring optics 26 or the image transmission line 27 and the feed line 19 can be moved independently of one another.

The CO₂ pellets 17 may be directed progressively onto the surface 13 along a prescribed movement pattern (for example in a scanning movement), so that the contaminating substances 14 are gradually removed completely from the surface 13. The monitoring device 25 allows the cleaning operation to be followed visually by an operator, or by an electronic evaluation device, and, in dependence on the recorded image of the surface 13 or the contaminating substances 14 deposited there, influence to be exerted on the cleaning process, for example in that a departure is made from the prescribed movement pattern.

The cleaning device 15 further comprises a suction extracting device 30 for extracting removed contaminating substances 14 and/or CO₂ or inert gas from the interior housing space 3. After they are incident on the surface 13, the CO₂ pellets 17 typically go over into the gaseous state, so that, after the removal of the substances 14 from the surface 13 by the suction extracting device 30, a mixture of CO₂ and these substances 14 can be extracted from the housing 2. The suction extracting device 30 has for this purpose in FIG. 2 three suction extracting lines 31, which at one end respectively enter the interior housing space 3 in a gastight manner. The suction extracting lines 31 are brought together at the other end in a main suction extracting line 32, in which a filter unit (not represented) for filtering out the contaminating extracted substances 14 is mounted. The main suction extracting line is in connection with a pump, for example a vacuum cleaner.

The CO₂ cleaned of the contaminating substances 14 by such a filter unit may subsequently be reused for generating the CO₂ pellets 17, in that it is cooled down. The gastight feeding of the CO₂ pellets 17 into the housing 2 and the gastight extraction by the suction extracting device 30 allow a hermetically sealed and closed cleaning cycle to be formed, allowing the cleaning procedure described here to be carried out in a cleanroom environment. In FIG. 2, the middle of the three suction extracting lines 31 enters the interior of the housing 3 through the opening 23, in which the feed line 19 and the image transmission line 27 are also led into the interior of the housing 3. All of the suction extracting lines 31 also enter the interior of the housing 3 in the region of the surface 13 to be cleaned by way of connection parts formed as suction extracting funnels 33.

In FIG. 2, a possible flow path of the cleaning cycle is represented by the line 18. In a first section, the gas stream 18 as a mixture of inert gas and the CO₂ pellets 17 is directed from the outlet opening 20 in the direction of the surface 13. There, the CO₂ pellets 17 perform their cleaning action and increasingly carry away the deposited substances 14. On impact, or thereafter, the CO₂ pellets 17 are transformed virtually completely into gaseous CO₂. According to the further flow path of the line 18, the mixture of removed substances 14 and gaseous CO₂ can then be extracted from the interior of the housing 3 through the suction extracting funnels 33 and the suction extracting line 31. Corresponding to the size of the surface 13 to be cleaned, it is possible to provide a number of suction extracting funnels 33 and corresponding suction extracting lines 31, which typically all extract the deposited substances 14 at the same time.

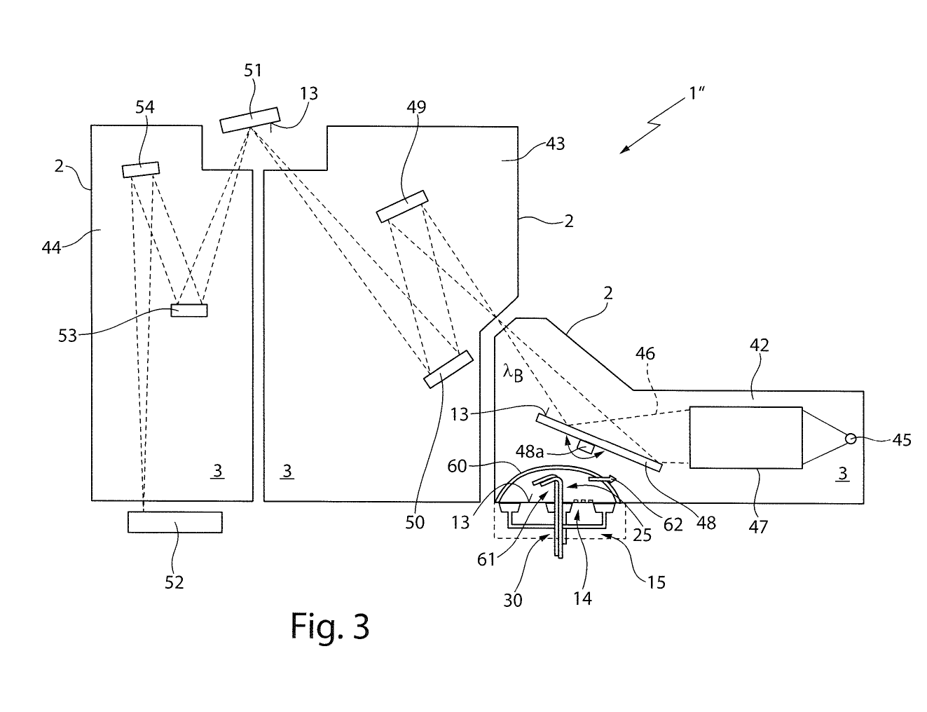

In FIG. 3, an optical arrangement formed as an EUV lithography apparatus 1″ is represented. The EUV lithography apparatus 1″ has a beam generating system 42, an illumination system 43 and a projection system 44, which are accommodated in separate housings 2 and are arranged one following the other in a beam path 46 emerging from the EUV light source 45 of the beam generating system 42. The beam generating system 42, the illumination system 43 and the projection system 44 are arranged in a common vacuum housing that is not represented. The radiation emerging from the light source 45 in the wavelength range between about 5 nm and about 20 nm is first focused in a collimator 47. With the aid of a downstream monochromator 48, the desired operating wavelength 4, which in the present example is about 13.5 nm, is filtered out by variation of the angle of incidence, as indicated by a double-headed arrow. The collimator 47 and the monochromator 48 are formed as reflective optical elements.

The radiation treated in the beam generating system 42 with regard to wavelength and spatial distribution is introduced into the illumination system 43, which has a first and a second reflective optical element 49, 50. The two reflective optical elements 49, 50 guide the radiation onto a photomask 51 as a further reflective optical element, which has a structure that is imaged by the projection system 44 onto a wafer 52 on a reduced scale. For this purpose, a third and a fourth reflective optical element 53, 54 are provided in the projection system 44.

The reflective optical elements 49, 50, 51, 53, 54 respectively have an optical surface 13, which is exposed to the EUV radiation 46 of the light source 45. The optical elements 49, 50, 51, 53, 54 are operated here under vacuum conditions, i.e. at (overall) pressures between about 10⁻⁹ mbar and about 10 mbar. For setting such vacuum conditions, a vacuum generating unit is provided (not shown).

Inside the EUV projection illumination apparatus 1″, i.e. in the EUV light source 45, in the beam generating system 42, in the illumination system 43 and/or in the projection system 44, there are typically contaminating substances 14, which originate from various sources or occur for various reasons. The EUV light source 5 may be for example a plasma light source, in which droplets of molten tin are shot at a high-power pulsed carbon-dioxide laser, whereby tin particles can enter the area around the light source 5 and subsequently spread out in the beam generating system 42. Furthermore, the monochromator 8 is mounted mechanically pivotably in the beam shaping system 42, as indicated by the double-headed arrow. However, mechanical abrasion may occur during the mechanical pivoting and likewise lead to the formation of contaminating substances.

All of these substances may be deposited in individual subassemblies of the EUV lithography apparatus 1″, for example on the inner surfaces 13 of the housings 2 enclosing the individual subassemblies (beam shaping system 42, illumination system 43, projection system 44, EUV (plasma) light source 45) and also on components that are present there, and migrate from one subassembly (for example the beam shaping system 42) to the next (for example the illumination system 43) and thereby have adverse effects on the operation of the EUV lithography apparatus 1″. The contaminating substances 14 may also be deposited on the optical surfaces 13 of the optical elements 47, 48, 49, 50, 51, 53, 54 themselves, whereby the reflectivity of the optical elements 47, 48, 49, 50, 51, 53, 54 decreases in a disadvantageous way.

By way of example and by analogy with FIGS. 1 and 2, in FIG. 3 there is shown on the underside of the beam generating system 42 the cleaning device 15 for removing substances 14 deposited on the surfaces 13 of the housing 2 of the beam generating system 42, which has the monitoring device 25 for monitoring the surface 13 and also the suction extracting device 30 for extracting removed contaminating substances 14 and/or fed-in CO₂. The cleaning device 15, the monitoring device 25 and the suction extracting device 30 allow the surfaces 13 of the housing 2 to be cleaned effectively of the contaminating substances 14, in particular of tin deposits from the EUV light source 45. The same applies to non-optical components that are arranged in the respective housing 2, for example to mountings of a respective optical element 47, 48, 49, 50, 51, 53, 54, as shown by way of example for a mounting 48a of the monochromator 48. It is also possible in principle to clean the surfaces 13 of the optical elements 49, 50, 51, 53, 54 at least partially with the CO₂ pellets 17, in particular at the points at which cleaning by conventional methods is no longer successful or is not possible.

Also arranged in the housing 2 of the beam generating system 42 is a space dividing device 60, which lies against the inner side of the housing 2 in a gastight or sealing manner. The space dividing device 60 surrounds the cleaning device 15, to be more precise the part of the cleaning device 15 that protrudes into the interior housing space 3, and also the surface 13 to be cleaned. In the situation represented in FIG. 3, the space dividing device 60 delimits a closed-off partial volume 61 of the interior housing space 3, so that the CO₂ pellets 17 and also the substances detached from the surface 13 during the cleaning cannot pass from the partial volume 61 into the remaining interior housing space 3 and be incident there on the optical surfaces 13 of the optical elements 47, 48.

In order also to clean withthe cleaning device 15 surfaces 13 that are disposed outside the partial volume 61 that is delimited in FIG. 3 by the position of the space dividing device 60, the space dividing device 60 may for example be offset (pivoted and/or moved) for example in the direction of the arrow 62. For this purpose, the space dividing device 60 may be assigned a drive (not shown). The movement of the space dividing device 60 in the housing 2 may take place for example along guides mounted in the interior housing space 3, for example in the form of guide rails. The space dividing device 60 may be displaced during the cleaning operation in the interior housing space 3, while the cleaning device 15 remains fixed in place and only the feed line 19 of the feeding device 35 and also the image transmission line 27 of the monitoring optics 26 are suitably moved, in order to reach points to be cleaned on the surface 13 or on further surfaces.

The cleaning device 15 may be detachably fastenable to the housing 2. For example, for cleaning purposes, the cleaning device 15 may be inserted into the housing 2 by way of an adapter or an opening. If no cleaning is required, the cleaning device 15 is removed and the adapter or the opening is closed in a gastight manner.

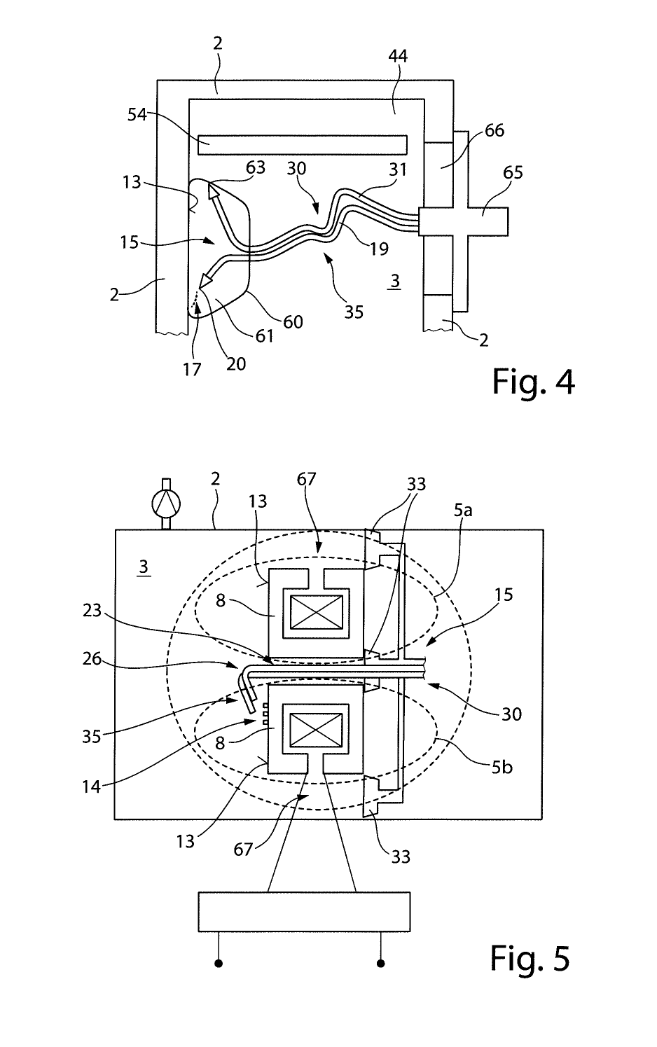

In FIG. 4, a detail of the EUV lithography apparatus 1″ from FIG. 3 is represented, to be precise a detail of the projection system 44 with the fourth reflective optical element 54. Likewise arranged in the housing 2 of the projection system 44 is a space dividing device 60, which lies against the inner side of the housing 2 in a gastight manner. The space dividing device 60 surrounds the surface 13 to be cleaned and also the outlet opening 20 of the feed line 19 and an end 63 on the inlet side of the suction extracting line 31 of the cleaning device 15 and, as shown in FIG. 3, in its position lying against the inner side of the housing 2, delimits a closed-off partial volume 61 of the interior housing space 3, so that CO₂ pellets 17 emerging from the feeding device 35, in particular from the outlet opening 20, and also the substances detached from the surface 13 during the cleaning can be removed again from the partial volume 61 by way of an end 63 on the inlet side of the suction extracting line 31, and consequently cannot get into the remaining interior housing space 3. The space dividing device 60 allows cleaning of the surface 13 also in the direct vicinity of the reflective optical element 54 without the latter coming into contact with the CO₂ pellets 17.

In order also to clean surfaces 13 that are disposed outside the partial volume 61 that is delimited in FIG. 4 by the position of the space dividing device 60 with the cleaning device 15, the space dividing device 60 may, as described further above in connection with FIG. 3, be offset in the interior housing space 3 and for example be laid in a gastight manner against further inner sides of the housing 2. In order to allow greatest possible flexibility during the cleaning, both the feed line 19 of the feeding device 35 and the suction extracting line 31 of the suction extracting device 30 are respectively formed substantially over their entire length as flexible sections of line, which in the interior housing space 3 run between the space dividing device 60 and an adapter 65, by way of which the cleaning device 15 is connected to the housing 2. For reasons of overall clarity, the image transmission line, which is arranged next to the feed line 19, has not been depicted in FIG. 4. The monitoring optics 26 are typically likewise arranged in the partial volume 61 that is delimited by the space dividing device 60.

As in FIG. 3, the cleaning device 15 is detachably connected to the housing 2, i.e. the adapter 65 on which the feeding device 35 and the suction extracting device 30 are held can be fastened to the housing 2 for the cleaning. When no cleaning is required, the cleaning device 15 can be detached from the housing 2 and the opening 66 on the housing 2 can be closed with a covering or the like.

FIG. 5 finally shows a schematic cross section through the plasma light source 1′ from FIG. 1, the cleaning device 15 being arranged further inside the housing 2, to be precise in the region of the primary coil 8. In this case, the feeding device 35 and the observation device 26 are led through the central (“pinch”) region, at which the two plasma loops 5a, 5b converge during the operation of the plasma light source 1′, i.e. this region forms the opening 23 through which the feed line 19 is led into the interior housing space 3. A first suction extracting funnel 33 of the suction extracting device 30 is also arranged at the central region. Furthermore, two further suction extracting funnels 33 are connected to channels 67, which are formed between the primary coil 8 and the inner sides of the housing 2. The cleaning device 15 consequently allows contaminating substances 14 to be removed for example from the surfaces 13 formed on the sides of the primary coil 8 and to be extracted by way of the suction extracting device 30. Also in this example, the cleaning operation can be tracked by using the observation device 26.

Instead of a plasma light source 1′ or an EUV lithography apparatus 1″, chambers or housings of other arrangements, in particular those in which a plasma is generated, may also be cleaned with the cleaning method described above. Such arrangements may for example also have chambers for depositing substances from the gas phase onto (optical) surfaces. The feeding of the CO₂ pellets 17 in the manner of an endoscope that is described above may also be replaced by some other kind of feeding device, in which no flexible sections are provided. Also, instead of the endoscope-like monitoring device 25, some other kind of online observation or monitoring device may be used for monitoring the CO₂ pellet cleaning.

What is claimed is:

1. An optical arrangement, comprising:
a housing, which encloses an interior housing space,
a vacuum generating unit configured to generate a vacuum in the housing,
at least one surface disposed in the interior housing space, and
a cleaning device configured to remove contaminating substances deposited on the surface, with a discharge of CO₂ formed as CO₂ pellets, and
a monitoring device configured to monitor the surface, wherein the monitoring device comprises monitoring optics configured to be directed onto the surface.

2. The arrangement according to claim 1, wherein the cleaning device comprises a feeding device configured to feed the CO₂ pellets to the surface, wherein the feeding device comprises a feed line with an outlet opening configured to discharge the CO₂ pellets, the feed line having at least one flexible section of line configured to direct the outlet opening onto various points of the surface.

3. The arrangement according to claim 2, wherein the feed line is inserted gastight in the interior housing space through an opening in the housing.

4. The arrangement according to claim 3, wherein the feed line is configured to displace and/or rotate in relation to the housing opening for directing the outlet opening.

5. The arrangement according to claim 1, wherein the monitoring device comprises an image transmission line, on which the monitoring optics are mounted, the image transmission line having at least one flexible section of line for directing the monitoring optics onto various points of the surface.

6. The arrangement according to claim 5, wherein the feed line and the image transmission line are arranged adjoining one another.

7. The arrangement according to claim 1, wherein a direction of discharge of the CO₂ pellets and a monitoring direction of the monitoring optics extend parallel to one another.

8. The arrangement according to claim 1, wherein the cleaning device further comprises: a suction device for extracting removed contaminating substances and/or CO₂ from the housing interior space.

9. The arrangement according to claim 8, wherein the suction extracting device has at least one suction extracting line entering the interior housing space gastight.

10. The arrangement according to claim 9, wherein the suction extracting line enters the interior housing space in a vicinity of the surface.

11. The arrangement according to claim 9, wherein the suction extracting line enters the interior housing space through an opening of a feed line for feeding in the CO₂ pellets.

12. The arrangement according to claim 1, wherein the surface is an inner surface of a housing of a plasma light source.

13. The arrangement according to claim 1, wherein the surface is disposed on a component arranged in the interior housing space.

14. The arrangement according to claim 13, wherein the component is formed as a mounting for an optical element.

15. The arrangement according to claim 1, wherein the surface is an optical surface of an optical element reflecting extreme ultraviolet radiation.

16. The arrangement according to claim 1, further comprising a space dividing device at least partially surrounding the surface and the cleaning device.

17. The arrangement according to claim 16, wherein the outlet opening of the feed line and an end on the inlet side of the suction extracting line are surrounded by the space dividing device.

18. The arrangement according to claim 1, configured as a plasma light source or an lithography apparatus operating with extreme ultraviolet light.

19. The arrangement according to claim 4, wherein a rigid section of the feed line is displaceable and/or rotatable in relation to the opening for directing the outlet opening.

20. The arrangement according to claim 6, wherein the feed line and the image transmission line are connected to one another at least in sections of the feed line and the image transmission line.

21. The arrangement according to claim 14, wherein the component is a mounting for a mirror configured to operate in the extreme ultraviolet.

22. The arrangement according to claim 16, wherein the space dividing device surrounds the surface and the cleaning device to form a gastight seal in the interior housing space.
